(19) United States
(12) Patent Application Publication
(10) Pub. No.: US 2026/0257897 A1
(43) Pub. Date: Sep. 3, 2026

(54) GASOLINE-ELECTRIC HYBRID OPERATING SYSTEM OF TRUCK CRANE, AND CRANE

(71) Applicant: XUZHOU HEAVY MACHINERY CO., LTD., Jiangsu (CN)

(72) Inventors: Zenghai SHAN, Jiangsu (CN); Honggang DING, Jiangsu (CN); Jianguo ZHAO, Jiangsu (CN); Jianli LIU, Jiangsu (CN); Guoxuan SUN, Jiangsu (CN)

(73) Assignee: XUZHOU HEAVY MACHINERY CO., LTD., Jiangsu (CN)

(21) Appl. No.: 18/879,808

(22) PCT Filed: Dec. 22, 2022
(86) PCT No.: PCT/CN2022/140913

§ 371 Date: Dec. 30, 2024

(30) Foreign Application Priority Data
Jul. 5, 2022 (CN) 202210783095.3

(51) Int. Cl. B66C 23/40; B60S 9/10; B60W 10/30; B60W 20/13; B60W 30/188; B66C 13/20; B66C 13/30

(52) U.S. Cl. CPC B66C 23/40; B60W 10/30; B60W 20/13; B60W 30/1886; B66C 13/20; B66C 13/30; B60S 9/10; B60W 2710/021; B60W 2710/244; B60W 2710/305

(57) ABSTRACT

The invention discloses a gasoline-electric hybrid operating system of a truck crane, and a crane, and belongs to the technical field of construction machines. The gasoline-electric hybrid operating system includes an engine, an all-in-one controller, a power battery, a BMS and a range-extending mechanism; the power battery is connected to the BMS, and the BMS is connected to the all-in-one controller; the all-in-one controller is connected to a high-voltage slip ring of a central revolving body, and the high-voltage slip ring of the central revolving body is connected to a first motor controller; and the range extending mechanism includes an ISG and a second motor controller. In the presence of an external power supply, power is supplied to an upper operating motor of a truck crane by the external power supply; in the absence of the external power supply, the engine drives the ISG to generate power.

### TECHNICAL FIELD

The invention relates to a gasoline-electric hybrid operating system of a truck crane, and a crane, and belongs to the technical field of construction machines.

### DESCRIPTION OF RELATED ART

With the rapid development of engineering technology, China lays increasingly more emphasis on construction machines, construction cranes are developing towards low consumption, low emission, electrification and intellectualization, and higher requirements are put forward for the overall performance of cranes. Power for traveling and power for operation of an upper body of a traditional truck crane are both from an engine, but the optimal power range of the engine during traveling is drastically different from the optimal power range of the engine during operation of the upper body, and the engine starts and stops frequency during operation of the upper body, so the two optimal power ranges of the engine cannot be balanced, making it impossible for the engine to operate within the most economical range. When the truck crane is in an uphill condition or a hill-start condition, a high power that exceeds the most economical range of the engine is required, increasing gasoline consumption. When the truck crane is in a downhill condition or a brake condition, energy recovery cannot be realized, leading to a waste of energy of the engine. When only electric power is used as a power source, because the operating location and time of the crane are not fixed, the hoisting efficiency and transport efficiency will be affected by the battery life, making it difficult to realize wide popularization.

### BRIEF SUMMARY OF THE INVENTION

The objective of the invention is to overcome the defects in the prior art by providing a gasoline-electric hybrid operating system of a truck crane and a crane to solve the problems of low energy utilization efficiency and large pollutant emission in operation of an engine of existing truck cranes.

To fulfill the above objective/solve the above technical problems, the invention adopts the following technical solution: a gasoline-electric hybrid operating system of a truck crane comprises an engine, an all-in-one controller, a power battery, a battery management system (BMS) used for controlling charge and discharge of the power battery and detecting a state of charge of the power battery, and a range extending mechanism;
the power battery is connected to the BMS, and the BMS is connected to the all-in-one controller;
the all-in-one controller is connected to a high-voltage slip ring of a central revolving body, the high-voltage slip ring of the central revolving body is connected to a first motor controller used for controlling operation of an upper body, and the all-in-one controller is connected to a third motor controller used for controlling operation of outriggers on a lower body;
the range extending mechanism comprises an integrated starter generator (ISG) and a second motor controller used for controlling the ISG; the ISG is connected to the second motor controller, and the second motor controller is connected to the all-in-one controller; and an output end of a crankshaft of the engine is connected to the ISG, and an output end of the ISG is connected to a clutch of a truck crane.

Optionally, the all-in-one controller is connected to an on-board charger used for charging the power battery, and the on-board charger is provided with an external power input port.

Optionally, the engine has an operating condition, and the operating condition comprises a plug-in operating mode and a range-extended operating mode.

Optionally, when the on-board charger is connected to an external power supply, the engine is in the plug-in operating mode and stops operating; and when the on-board charger is not connected to the external power supply, the engine is in the range-extended operating mode and drives the ISG to generate power.

Optionally, the engine has a starting condition, an idling condition and a traveling condition.

Optionally, when the engine is in the starting condition, the power battery supplies power to the ISG, and the second motor controller controls the ISG to work and drive the engine to start, and the clutch is in a disengaged state.

Optionally, when the engine is in the idling condition, the state of charge of the power battery is low, and the second motor controller controls the ISG to charge the power battery; when the state of charge of the power battery is high, the ISG stops working, and the clutch is in a disengaged state.

Optionally, when the engine is in the traveling condition, the second motor controller controls the ISG to output a positive or negative torque, and the clutch is in an engaged state.

Optionally, the first motor controller is connected to an upper operating motor, and the upper operating motor is connected to a first hydraulic pump used for driving an upper operating system; the third motor controller is connected to an outrigger motor, and the outrigger motor is connected to a second hydraulic pump used for driving outriggers on the lower body is act.

A crane comprises the gasoline-electric hybrid operating system of a truck crane

Compared with the prior art, the invention fulfills the following beneficial effects:

1. In the invention, during operation of the upper body, if an external power supply is available, power is supplied to the upper operating motor of the truck crane by the external power supply to realize pure electric operation and zero gasoline consumption; if no external power supply is available, the engine drives the ISG to generate power to implement range-extended operation of the upper body. In this way, the engine always operates within a high efficiency range, thus greatly reducing gasoline consumption during operation of the upper body and solving the problems of low energy utilization efficiency and large pollutant emission in operation of an

2. In the invention, when the engine is in the starting condition, the idling condition and the traveling condition, the ISG motor provides traveling power and generates power properly, thus improving the working efficiency of the engine and reducing gasoline consumption and exhaust emission.

3. In the invention, the all-in-one controller controls the first motor controller and the third motor controller respectively to control the upper operating motor and the outrigger motor on the lower body so as to control the first hydraulic pump on the upper body and the second hydraulic pump on the lower body, such that an upper hydraulic system and a lower hydraulic system are separated, and hydraulic transfer does not need to be performed by the central revolving body, thus improving the working efficiency of the system and reducing the loss of energy.

### BRIEF DESCRIPTION OF THE SEVERAL VIEWS OF THE DRAWINGS

FIG. 1 is a schematic diagram of a gasoline-electric hybrid operating system of a truck crane according to one embodiment.

### IN THE FIG

1, engine; 2, all-in-one controller; 3, power battery; 4, BMS; 5, range extending mechanism; 501, ISG; 502, second motor controller; 6, high-voltage slip ring of central revolving body; 7, first motor controller; 8, upper operating motor; 9, first hydraulic pump; 10, third motor controller; 11, outrigger motor; 12, second hydraulic pump; 13, clutch; 14, on-board charger.

### DETAILED DESCRIPTION OF THE INVENTION

The invention is further described below in conjunction with the accompanying drawing. The following embodiments are merely used for more clearly explaining the technical solutions of the invention and should not be constructed as limitations of the protection scope of the invention.

In the description of invention, it should be understood that terms such as “central”, “longitudinal”, “transverse”, “upper”, “lower”, “front”, “back”, “left”, “right”, “vertical”, “horizontal”, “top”, “bottom”, “inner” and “outer” are used to indicate directional or positional relations based on the accompanying drawing merely for the purpose of facilitating and simplifying the description of the invention, do not indicate or imply that devices or elements referred to must be in a specific direction or be configured and operated in a specific direction, and thus should not be construed as limitations of the invention. In addition, terms “first” and “second” are merely for the purpose of description, and should not be construed as indicating or implying relative importance or implicitly indicating the number of technical features referred to. Therefore, a feature defined by “first” or “second” may explicitly or implicitly indicate the inclusion of one or more said features. In the description of the invention, “multiple” refers to two or more, unless otherwise stated.

In the description of the invention, it should be noted that unless otherwise expressly stated and defined, terms “mount”, “connect” and “link” should be broadly understood. For example, “connect” may refer to fixed connection, detachable connection or integrated connection; or, mechanical connection or electrical connection; or, direct connection, indirect connection by means of an intermediate medium, and internal connection of two elements. Those ordinarily skilled in the art can appreciate the specific meanings of these terms in the invention as the case may be.

### Embodiment 1

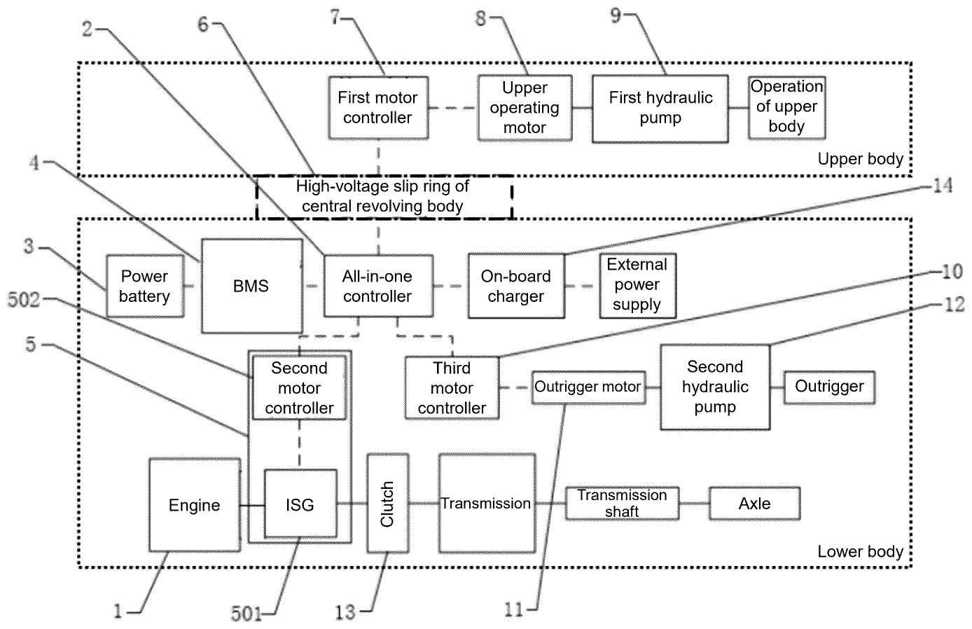

Referring to FIG. 1, a gasoline-electric hybrid operating system of a truck crane comprises an engine 1, an all-in-one controller 2, a power battery 3, a battery management system (BMS) 4, and a range extending mechanism 5, wherein the power battery 3 is mounted on a lower body of a truck crane and connected to the BMS 4, the BMS 4 is connected to the all-in-one controller 2 and can control charge and discharge of the power battery 3 and detect a state of charge of the the all-in-one controller 2 is connected to a high-voltage slip ring 6 of a central revolving body, the high-voltage slip ring 6 of the central revolving body is connected to a first motor controller 7 used for controlling operation of an upper body, the first motor controller 7 is connected to an upper operating motor 8, and the upper operating motor 8 is connected to a first hydraulic pump 9 and used for driving an upper operating system; the all-in-one controller 2 is connected to a third motor controller 10 and used for controlling operation of outriggers on the lower body; the third motor controller 10 is connected to an outrigger motor 11, and the outrigger motor 11 is connected to a second hydraulic pump 12 and used for driving the outriggers on the lower body to act; and the all-in-one controller 2 controls the first motor controller 7 and the third motor controller 10 respectively to control the upper operating motor 8 and the outrigger motor 11 on the lower body so as to control the first hydraulic pump 9 on the upper body and the second hydraulic pump 12 on the lower body, such that an upper hydraulic system and a lower hydraulic system are separated, and hydraulic transfer does not need to be performed by the central revolving body, thus improving the working efficiency of the system and reducing the loss of energy;
the range extending mechanism 5 comprises an integrated starter generator (ISG) 501 and a second motor controller 502 used for controlling the ISG 501; the ISG 501 is connected to the second motor controller 502, and the second motor controller 502 is connected to the all-in-one controller 2; an output end of a crankshaft of the engine 1 is connected to the ISG 501, and an output end of the ISG 501 is connected to a clutch 13 of the truck crane; the all-in-one controller 2 is connected to an on-board charger 14 used for charging the power battery 3, and the on-board charger 14 is provided with an external power input port; the engine 1 has an operating condition, and the operating condition comprises a plug-in operating mode and an range-extended operating mode; when the engine 1 is in the operating condition and the on-board charger 14 is connected to an external power supply, the engine 1 is in the plug-in operating mode, the engine 1 stops operating, the external power supply supplies power to the upper operating motor 8 by means of the on-board charger 14, the all-in-one controller 2, the high-voltage slip ring 6 of the central revolving body and the first motor controller 7, and the upper operating motor 8 drives the first hydraulic pump 9 to work to realize revolving, luffing or other actions of the upper body, and at the same time, the external power supply supplies power to the outrigger motor 11 by means of the all-in-one controller 2 and the third motor controller 10 to drive the outriggers to stretch or retract horizontally and vertically; in the plug-in operating mode, the on-board charger 14 charges the power battery 3 by means of the all-in-one controller 2 and the BMS 4, that is, power is supplied to the upper operating motor 8 of the crane truck by means of the external power supply and the on-board charger 14, such that pure electric operation and zero gasoline consumption are realized;
when the engine 1 is in the operating condition and the on-board charger 14 is not connected to the external power supply, the engine 1 is in the range-extended operating mode, the clutch 13 is in a disengaged state, the engine 1 drives the ISG 501 to generate power, the power is supplied to the upper operating motor 8 by means of the second motor controller 502, the all-in-one controller 2, the high-voltage slip ring 6 of the central revolving body and the first motor controller 7, the upper operating motor 8 drives the first hydraulic pump 9 to work to implement revolving, luffing and other actions of the upper body, at the same time, the power is supplied to the outrigger motor 11 on the lower body by means of the all-in-one controller 2 and the third motor controller 10 to drive the outriggers to stretch or retract horizontally and vertically; and in a case where no external power supply is available, the engine 1 drives the ISG 501 to generate power to realize range-extended operation of the upper body. In this way, the engine 1 always operates within a high efficiency range, thus greatly reducing gasoline consumption during operation of the upper body.

The engine 1 also has a starting condition, an idling condition and a traveling condition; when the engine 1 is in the starting condition, the power battery 3 supplies power to the ISG 501, the second motor controller 502 controls the ISG 501 to work and drives the engine 1 to start, and the clutch 13 is in the disengaged state; when the engine 1 is in the idling condition, the state of charge of the power battery 3 is low, and the second motor controller 502 controls the ISG 501 to start to charge the power battery 3; and when the state of charge of the power battery 3 is high, the ISG 501 stops working, and the clutch 13 is in the disengaged state; when the engine 1 is in the traveling condition, the clutch 13 is in an engaged state, traveling power of the truck crane is mainly provided by the engine 1 and transmitted to wheels by means of the clutch 13, a transmission, a transmission shaft and an axle to drive the truck crane to travel; when the truck crane is in a hill-start condition, an acceleration condition or an uphill condition, a high power that exceeds the high efficiency range of the engine 1 is needed, and at this moment, the second motor controller 502 controls the ISG 501 to output a positive torque to reduce the output torque of the engine 1, such that the engine 1 is allowed to work within the high efficiency range to the maximum extent, and gasoline consumption is reduced; and when the truck crane is in a downhill condition, a braking condition or coasting condition, the second motor controller 502 controls the ISG 501 to output a negative torque to generate power, and energy is recovered to charge the power battery 3, such that energy waste is avoided, and energy utilization efficiency is improved.

### Embodiment 2

A crane comprises the gasoline-electric hybrid operating system of a truck crane.

The above embodiments are merely preferred ones of the invention. It should be noted that those ordinarily skilled in the art can make some improvements and transformations without departing from the technical principle of the invention, and all these improvements and transformations should also fall within the protection scope of the invention.

1. A gasoline-electric hybrid operating system of a truck crane, comprising an engine, an all-in-one controller, a power battery, a battery management system (BMS) used for controlling charge and discharge of the power battery and detecting a state of charge of the power battery, and a range extending mechanism;
the power battery is connected to the BMS, and the BMS is connected to the all-in-one controller;
the all-in-one controller is connected to a high-voltage slip ring of a central revolving body, the high-voltage slip ring of the central revolving body is connected to a first motor controller used for controlling operation of an upper body, and the all-in-one controller is connected to a third motor controller used for controlling operation of outriggers on a lower body;
the range extending mechanism comprises an integrated starter generator (ISG) and a second motor controller used for controlling the ISG; the ISG is connected to the second motor controller, and the second motor controller is connected to the all-in-one controller; an output end of a crankshaft of the engine is connected to the ISG, and an output end of the ISG is connected to a clutch of a truck crane.

2. The gasoline-electric hybrid operating system of the truck crane according to claim 1, wherein the all-in-one controller is connected to an on-board charger used for charging the power battery, and the on-board charger is provided with an external power input port.

3. The gasoline-electric hybrid operating system of the truck crane according to claim 2, wherein the engine has an operating condition, and the operating condition comprises a plug-in operating mode and a range-extended operating mode.

4. The gasoline-electric hybrid operating system of the truck crane according to claim 3, wherein when the on-board charger is connected to an external power supply, the engine is in the plug-in operating mode and stops operating;
when the on-board charger is not connected to the external power supply, the engine is in the range-extended operating mode and drives the ISG to generate power.

5. The gasoline-electric hybrid operating system of the truck crane according to claim 1, wherein the engine has a starting condition, an idling condition and a traveling condition.

6. The gasoline-electric hybrid operating system of the truck crane according to claim 5, wherein when the engine is in the starting condition, the power battery supplies power to the ISG, and the second motor controller controls the ISG to work and drive the engine to start, and the clutch is in a disengaged state.

7. The gasoline-electric hybrid operating system of the truck crane according to claim 5, wherein when the engine is in the idling condition, the state of charge of the power battery is low, and the second motor controller controls the ISG to charge the power battery; when the state of charge of the power battery is high, the ISG stops working, and the clutch is in a disengaged state.

8. The gasoline-electric hybrid operating system of the truck crane according to claim 5, wherein when the engine is in the traveling condition, the second motor controller controls the ISG to output a positive or negative torque, and the clutch is in an engaged state.

9. The gasoline-electric hybrid operating system of the truck crane according to claim 1, wherein the first motor controller is connected to an upper operating motor, and the upper operating motor is connected to a first hydraulic pump used for driving an upper operating system; the third motor controller is connected to an outrigger motor, and the outrigger motor is connected to a second hydraulic pump used for driving outriggers on the lower body is act.

10. A crane, comprising the gasoline-electric hybrid operating system of the truck crane according to claim 1.
